(19) United States
(12) Patent Application Publication
(10) Pub. No.: US 2003/0174956 A1
(43) Pub. Date: Sep. 18, 2003

(54) Polarization insensitive modal field transformer for high index contrast waveguide devices

(76) Inventor: Jean-Francois Viens, Boston, MA (US)

Correspondence Address: Samuels, Gauthier & Stevens, LLP, Attn: Matthew E. Connors, Suite 3300, 225 Franklin Street, Boston, MA, 02110, US

(21) Appl. No.: 10/097,069

(22) Filed: Mar. 13, 2002

(51) Int. Cl. G02B 6/30

(52) U.S. Cl. 385/43; 385/49

(57) ABSTRACT

In a modal field transformer system, a standard single-mode fiber is connected to a high numerical aperture fiber, which is connected to an integrated waveguide mode converter that connects to a high numerical aperture photonic circuit. The modal field transformer combines adiabatic transitions in both the waveguide and the fiber to achieve low-loss and low polarization dependent optical mode conversion between the standard single-mode fiber and the single-mode high numerical aperture waveguide. The modal field transformer of the preferred embodiment can be used for input and output coupling.

### BACKGROUND OF THE INVENTION

In modern optical communications systems, processing, e.g., filtering and routing, of optical signals is performed in planar waveguide devices and transmission is performed in single mode optical fiber. As a result, an important metric for the performance of these systems is the efficiency with which the optical signals can be coupled between the planar waveguide devices and the single mode optical fiber.

Efficient coupling requires mode field matching at the physical interface between the optical fiber and the waveguide of the planar waveguide device. Otherwise, the modal mismatch at the abrupt fiber-to-waveguide connection will result in high insertion loss. The single mode fiber used in most transmission systems supports a mode field diameter of about 10 micrometers (μm). If a butt coupling interface is used, the planar waveguide device must therefore have waveguides that support mode field diameters of about 10 μm, which can be achieved in low refractive index contrast material systems (Δn/n˜0.4%).

Allowing the fiber mode field diameter to dictate the waveguide device's mode field diameter is an acceptable design constraint when planar waveguide devices are used that offer relatively low levels of integration or functionality. As higher functionality devices are developed, however, this design constraint becomes increasingly problematic. In many situations, 10 μm waveguide mode field diameters result in planar waveguide chips that are too big because of the physical size of the waveguides and the associated large minimum bend radii. Large chips are undesirable for two reasons: 1) the increased size of the optical component; and 2) increased expense to manufacture since fewer chips can be fabricated on each wafer from the fabrication line.

For planar waveguide devices fabricated in higher refractive index contrast material systems, some have proposed the use of high numerical aperture (NA) fiber segments between the standard single mode fibers and the planar waveguide device. This high NA fiber is used to transform the 10 μm mode of the single mode fiber to an approximately 6 μm mode, which corresponds to the mode sizes of the planar waveguide devices considered. In other cases, laterally tapered waveguides are used to increase the mode field diameter at the waveguide facet to match the 10 μm mode size of the standard single-mode fiber.

Tapered waveguides, however, raise the problem of polarization dependent loss (PDL). The problem arises because the tapering is performed along the waveguide's lateral direction. This destroys four-fold symmetry in the waveguide, which leads to different loss characteristics for the two polarization modes.

The use of waveguide tapers or high NA fiber segments is about the only alternative to performing the conversion using discrete lenses or lens systems. This technique, however, is expensive and typically requires expensive laser welding or solder reflow alignment equipment. Yet, it is the only available alternative when low insertion loss and low polarization sensitivity coupling are required between single mode fiber and waveguide devices in which the mode size is smaller than 10 μm.

### SUMMARY OF THE INVENTION

The invention concerns coupling between single mode fiber and higher index contrast planar waveguide devices in which the mode field diameter is less than standard single mode fiber. It relies on a combination of mode conversion both in fiber and in the planar waveguide device to achieve low insertion loss coupling. It can further be used to provide low polarization dependent coupling loss.

In an exemplary embodiment, the invention is used to couple fiber to high or very high index contrast planar waveguide devices in which the refractive index contrast Δn/n is greater than 2% between the waveguide core and waveguide cladding layers. In fact, it is used in ultra high index contrast devices in which the index contrast is greater than 5%, and specifically greater than 10%.

The invention addresses the problem of fiber-waveguide optical coupling losses at the fiber-waveguide interface by distributing the mode conversion over several adiabatic transitions and by minimizing mode mismatch at abrupt interfaces. The invention addresses the problem of polarization sensitivity of the fiber-waveguide optical interface by using low polarization dependent integrated waveguide mode converters. Misalignment sensitivity is also addressed by maximizing the mode size at the fiber-waveguide interface. The modal field transformer provides a simple cost-effective coupling solution by utilizing components connected using standard fabrication processes and simple assembly procedures.

In an exemplary embodiment, the modal field transformer is comprised of a standard single-mode fiber, such as Corning SMF-28, connected to a high numerical aperture fiber, which is connected to an integrated waveguide mode converter, which is connected to a high numerical aperture photonic circuit. The modal field transformer combines adiabatic transitions in both the waveguide and the fiber to achieve low-loss optical mode conversion between the integrated waveguide mode converter and the high NA photonic circuit, and between the standard single-mode fiber and the single-mode high numerical aperture fiber. The modal field transformer of the preferred embodiment can be used for input and output coupling.

The modal field transformer can have low coupling loss between the fiber and the waveguide, low polarization sensitivity, high tolerance to fiber-waveguide misalignments, and can be scaled to many input/output ports. The fabrication, connection, and assembly procedures are simple and low-cost.

The modal field transformer is most suitable for implementation in high NA optical waveguide devices so that industry standards regarding insertion loss and polarization sensitivity of optical devices can be met or exceeded.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

FIG. 1 is a side cross-sectional view of a schematic diagram of mode field transformer systems in accordance with the invention;

FIG. 2 is a perspective view of a waveguide taper of an integrated waveguide mode converter of the invention;

FIGS. 3A and 3B are plots of coupling efficiency for the TE and TM modes, respectively, for a range of numerical apertures for the fiber and widths of the converter;

FIG. 4 is a perspective view of another embodiment of the waveguide taper for the integrated waveguide mode converter of the invention; and

FIG. 5 is a top cross-sectional view of schematic diagram of a modal field transformer, in accordance with another embodiment of the invention in which multiple fiber segments and integrated waveguide mode converter sections are used.

### DETAILED DESCRIPTION OF THE INVENTION

The invention provides a modal field transformer for coupling an optical fiber to a high numerical aperture (NA) waveguide device. The modal field transformer is preferably comprised of waveguide and fiber sections. The modal field transformer is based on longitudinal structural changes in the fiber and in the waveguide, such as tapers, that change the confinement of a mode field and, thus, change the size and/or the shape of the mode field.

A modal field transformation is adiabatic if the transformation occurs sufficiently slowly longitudinally so that a minimal amount of optical energy of the desirable mode is transferred to undesirable modes, such as higher order modes or radiation modes. The adiabatic modal field transformations of the invention preserve the energy of the desirable mode, for any polarization state, as the optical core structure changes from fiber to fiber, from fiber to waveguide, from waveguide to fiber, or from waveguide to waveguide, with little energy transfer to undesirable modes in the optical core structure or to radiation modes in the optical cladding structure.

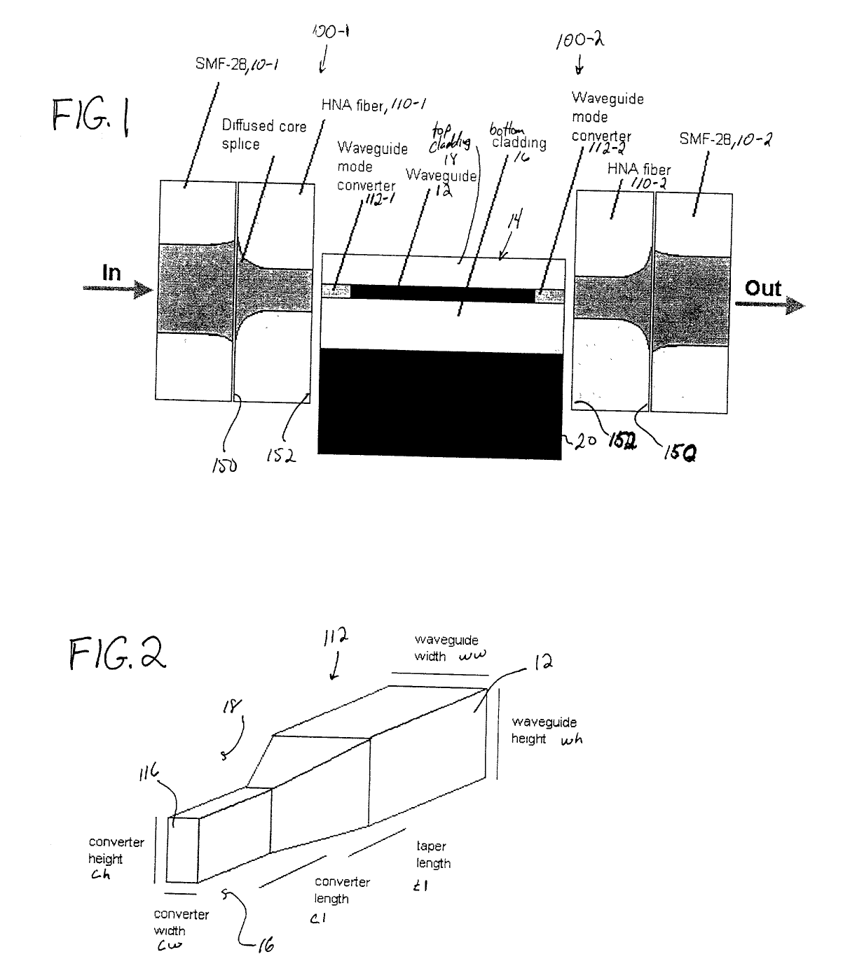

FIG. 1 is a side cross-sectional view of a schematic diagram of a mode field transformer system in accordance with the invention. FIG. 1 shows a mode field transformer system between optical fibers 10-1, 10-2 and waveguides 12 of a planar waveguide device 14, which transformer system has been constructed according to the principles of the invention.

Specifically, two modal field transformers are used: an input modal field transformer 100-1 and an output modal field transformer 100-2.

The input modal field transformer 100-1 comprises a single mode fiber (SMF) 10-1 that is connected to a high NA fiber segment 110-1, which is connected to a waveguide mode converter 112-1. The waveguide mode converter 112-1 is connected to a photonic circuit of the planar waveguide device.

The output modal field transformer 100-2 comprises a similar sequence of components. A waveguide mode converter 112-2 is connected to a high NA fiber segment 110-2, which is connected to a single mode fiber 10-2. To minimize coupling loss, adiabatic taper sections are used in the waveguide mode converter and in the high NA fiber.

In the illustrated embodiment, planar waveguide device or chip 14, including the waveguide mode converters 112-1, 112-2, waveguides 12, and photonic circuits are monolithically fabricated in a high index contrast material system.. That is, the material system provides an index contrast between the refractive indices of the waveguide core 12 and the bottom and top waveguide cladding layers 16, 18 that is greater than 2%, or preferably a higher contrast of greater than 5%. Presently, a silicon oxy-nitride system is used in which the refractive index of the waveguides is 1.60 and the refractive index of the cladding layers is about 1.44. Thus, Δn/n_{cladding} is greater than about 10%. As a result, the typical mode field diameter in the photonic circuit is smaller than 2 μm or about 1.8 μm.

In one implementation, a standard single-mode fiber 10-1, such as Corning SMF-28, is coupled to a High Numerical Aperture single-mode fiber (HNA fiber) 110-1. A preferred low-loss adiabatic modal transformation is achieved by using thermally diffused expanded core (TEC) splicing, between the SMF-28 fibers 10-1, 10-2 and the respective HNA fiber segments 110-1, 110-2. By virtue of material thermal diffusion, the thermally diffused expanded core technique smoothes and tapers the otherwise discontinuous optical core structures at the spliced fiber junction. The discontinuity includes core diameter and numerical aperture differences. The tapering is gradual so that the transition between the two fibers is adiabatic instead of abrupt, and the coupling loss at the spliced junction is minimized. Specifically, at the ends 150 of the HNA fiber segments 110 that are distal to the waveguide device 14, the numerical apertures is similar to the single mode fiber 10. However, at the proximal ends 152 of the segments 110, the numerical aperture is greater than the single mode fiber.

Both the SMF-28 fibers 10-1, 10-2 and HNA fiber segments 110-1, 110-2 preferably have a circular geometry. Thus, the taper from the SMF-28 fiber to the HNA fiber has rotational symmetry and is polarization insensitive if the splicing is properly done. A splice loss of less than 0.1 dB can typically be achieved using this technique with low polarization sensitivity, as compared to a splice loss of more than 1 dB for an abrupt fiber junction.

Next, the HNA fiber segments 110-1, 110-2 are coupled to the integrated waveguide mode converters 112-1, 112-2. This junction is abrupt because of the structural discontinuity between the fiber and the waveguide at this coupling interface. The structural discontinuity exists because of a size difference between the large fiber and the narrow waveguide cores, a shape difference from circular fiber to rectangular waveguide, and a numerical aperture difference from high NA fiber to the higher NA waveguide. Presently, the NA of the fiber segments 110-1, 110-2 is greater than 0.15 or preferably about 0.30, resulting in a mode field diameter smaller than 10 μm or about 5 μm, whereas the NA of the planar waveguide device 14 is higher than 0.30 or about 0.70.

In order to preserve as much of the mode energy at this structural discontinuity, and thus minimize the generation of undesirable modes, such as higher order modes and radiation modes, the cross-sections of the integrated waveguide mode converters 112-1, 112-2 are shaped and designed for transverse mode matching, where the mode in the HNA fiber and the mode in the integrated waveguide mode converter have optimal mode overlap at the coupling interface.

Currently, during the design process, the integrated waveguide mode converter cross-sections are designed and optimized using numerical electromagnetic field calculation tools. The mode matching reduces the loss at the abrupt transition. Also, the integrated waveguide mode converter cross-section is shaped and optimized to provide low coupling polarization sensitivity at this interface.

The waveguide taper can have various cross-sectional shapes depending on the cross-section and core index of the waveguide photonic circuit, the cross-section and core index of the HNA fiber, the desired coupling loss, the desired polarization sensitivity, and the lithographic capability.

FIG. 2 is a perspective view of an I-shaped waveguide taper 112 that is used as the integrated waveguide mode converters 112-1, 112-2 in one embodiment. The mode converters 112-1, 112-2 have a number of parameters that are optimized for high coupling efficiency and low polarization sensitivity in the typical implementation. Specifically, the converter height ch and converter width cw at the proximal end or facet 116 of the waveguide are used to control the mode field diameter and the modes' aspect ratios.

The taper length tl is designed by taking into account the trade-off between adiabatic transition loss and substrate leakage loss, i.e., the taper is designed long enough to provide low-loss adiabatic transition from waveguide mode converter to waveguide 12, and short enough to minimize leakage loss in the substrate.

In the illustrated embodiment, the taper length tl was adjusted to 300m. This particular modal field transformer reduces the total coupling loss from 15 dB (no modal field transformer) to less than 1 dB (with modal field transformer) for a transition between a NA=0.13 fiber to a NA=0.69 waveguide and back to a NA=0.13 fiber, demonstrating the efficiency of the concept for both input and output interfaces. The concept is not restricted to these particular NA values.

The other dimensions of the integrated waveguide mode converter are optimized by using numerical methods and by mapping a parameter space, in order to search for optimized parameters providing optimally low coupling loss and low coupling polarization sensitivity according to one design process.

Mapping the 2-D parameter space of the numerical aperture of the HNA fiber 110 and the I-shaped waveguide taper width versus the coupling efficiency of the modal field transformer find regions of optimal coupling efficiency.

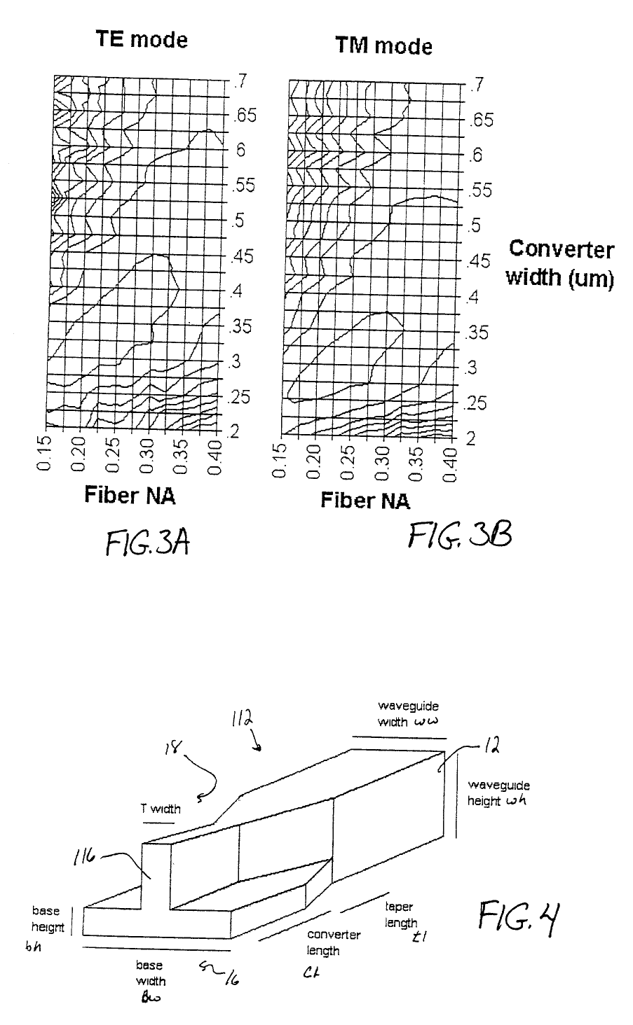

FIGS. 3A and 3B are plots of coupling efficiency for the TE and TM modes, respectively, for a range of numerical apertures for the fiber and widths of the converter. The plots were generated using standard single-mode SMF-28 fiber with NA=0.14, high NA fiber, and an I-shaped waveguide taper with a NA=0.69 and a converter height of 1.3 m, as described with reference to FIGS. 1 and 2.

By specifying the I-shaped waveguide taper structural parameters (such as waveguide height=1.3 m and cladding thickness=6 m in this illustrated case) and the optical wavelength, a specific region of optimal modal field transformer coupling efficiency is isolated by numerical calculation. Then, the polarization sensitivity is obtained by minimizing the difference in coupling efficiency between the TE and TM modes.

A total modal field transformer coupling loss of less than 1 dB at a wavelength of 1550 nm can be obtained for I-shaped waveguide taper widths of about 0.30 m and for HNA Fiber NA of about 0.22, for both the Transverse Electric (TE) and the Transverse Magnetic (TM) polarization modes thus yielding polarization insensitivity (PDL<0.1 dB).

To make the modal field transformer cost-effective, the fiber waveguide coupling connection preferably utilizes simple connectivity and assembly procedures, low cost materials, and minimal lithographic steps. Simple, widely available fabrication procedures, which can be automated, can be used to physically couple the fiber to the waveguide so that labor costs are minimized.

In one implementation to reduce assembly cost and simplify the connection, the fiber-waveguide interface has planar facets with no intermediary lensing parts. The waveguide and the fiber are cut and polished prior to assembly, which eases fabrication and assembly. The waveguide and the fiber are then butt-coupled using an index matching epoxy, for example. The cut-and-polish and butt-coupling techniques can be easily scaled to waveguide arrays and fiber arrays for photonic devices with multiple input/output ports. Intermediary parts, such as micro-lenses or lens bars, between the fiber and the waveguide are thus eliminated and the material costs and the number of alignment and assembly steps are minimized.

To achieve cost-effective fabrication, the integrated waveguide mode converter can be fabricated with a minimal number of lithographic steps and can be fabricated on the same material layer as the high NA photonic circuit. The integrated waveguide mode converter illustrated in FIG. 2 can be fabricated with as few as one etching step (same etch step used to fabricate the waveguide circuit) if the converter height ch is equal to the waveguide height wh, i.e., without a taper in the transverse direction of the waveguide. Alternatively, the integrated waveguide mode converter of FIG. 2 can be fabricated with more than one etching steps for the vertically tapered configuration shown. Generally, minimizing the number of etching steps reduces the number of lithographic masks needed, the number of lithographic steps involved, and the overall cost of device fabrication.

The modal field transformer described in this embodiment has input/output structural and functional symmetry, so that it can be used in bi-directional operation. The modal field transformer can also be used for applications where the SMF-28 fiber is replaced with another type of fiber, such as NA˜0.20 erbium-doped gain fibers used for optical amplifiers at ˜1550 nm. As stated before, the structural symmetry allows the concept to be used to couple light from low-NA to high-NA devices, as well as from high-NA to low-NA devices.

To achieve maximum tolerance to fiber misalignment, the HNA fiber 110 and the integrated waveguide mode converter 112 preferably carry as large a modal field as possible at the waveguide-fiber interface to reduce lateral and longitudinal misalignment sensitivity at the interface, and thus make the modal field transformer tolerant to misalignments.

Generally, the modal field size at the waveguide-fiber interface can be increased by reducing the cross-section of the mode converter 112 and by using a minimally low-NA HNA fiber 110. The HNA fiber 110 is said to be minimally low if the modal field at the fiber-waveguide interface extends to the maximum space provided by the waveguide cladding structure 16, 18. The numerical aperture of the HNA fiber can be reduced, and the modal field diameter increased, based on the space allocated by the waveguide cladding before substrate leakage loss becomes high. By virtue of mode overlap, increasing the modal field diameter at the fiber-waveguide interface increases the tolerance of coupling loss to lateral and longitudinal fiber misalignments. The maximum modal field diameter at the fiber-waveguide interface for maximum alignment tolerances depends on the waveguide cladding thickness, and more particularly on the capability of the integrated waveguide mode converter to support a large modal field without leakage loss into the waveguide substrate 20. The cladding thickness is usually determined by fabrication capability, which can be a constraint when using Complementary Metal Oxide Semiconductor (CMOS) based fabrication technology, in the example of the current implementation.

There can be a trade-off between maximum tolerance to misalignments and optimally low coupling loss. The coupling tolerance requires that the high NA fiber 110 have an NA as low as possible, while the coupling loss requires a specific NA value of HNA fiber. Therefore, the maximum-tolerance coupling may not provide optimally low coupling loss. For example, for some non-telecommunication applications, where insertion loss is not a critical issue, the maximum-tolerance coupling, to improve reliability, can be more important than optimally low coupling loss, and therefore the coupling loss efficiency requirement can be relaxed for the benefit of increasing the coupling tolerance to misalignments.

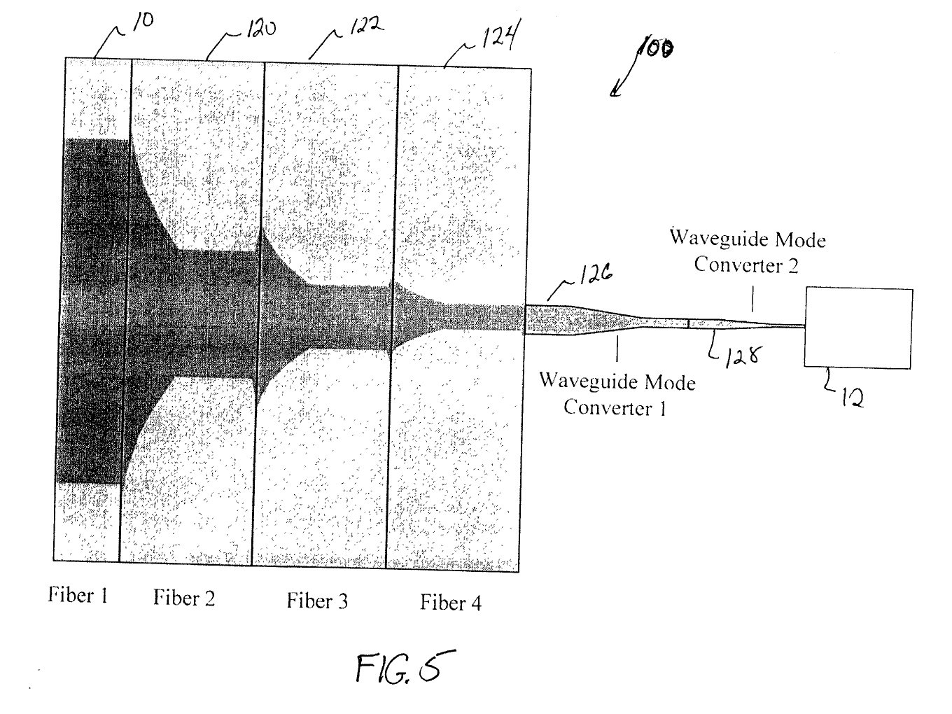

FIG. 4 is a perspective view of another embodiment of the waveguide taper for the integrated waveguide mode converter of the invention. FIG. 4 shows a T-shaped waveguide taper that is used as the integrated waveguide mode converters 112-1, 112-2 in another embodiment. This embodiment adds additional parameters bh and bw related to the base height and base width of the converter 112. These parameters are typically used to adjust the relative coupling efficiency of the TE and TM modes and reduce loss to the substrate.

FIG. 5 is a top cross-sectional view of schematic diagram of a modal field transformer system 100, in accordance with another embodiment of the invention in which multiple fiber segments and integrated waveguide mode converter sections are used. Here, the modal field transformer system comprises multiple high NA fiber segments 120, 122, 124 serially connected between a single mode fiber 10 and serial integrated waveguide mode converters 126, 128.

As illustrated, the field transformer can have any number of fiber sections and any number of waveguide converters to reduce the amount of coupling loss at each interface. Multiple sections can be used to produce an adiabatic transition over the sections so that the modes and polarizations can be more optimally matched at each interface.

In general, the embodiments described above can also be applied to thermally expanded core splices between SMF-28 and elliptical core high NA fiber, or other polarization maintaining high NA fibers. Because of the rotational asymmetry of such a spliced structure (due to the different fiber core shapes) and the differing amounts of adiabatic perturbation seen by the different polarization states as they propagate across the spliced structure, the TEC is not polarization insensitive. However, by using a long TEC taper, the polarization dependent loss of the splice can be reduced to negligible values. This particular embodiment can be used for applications where maintenance of the light's polarization is critical.

The high NA fiber segments 110-1, 110-2 of the first embodiment, shown in FIG. 1, can be replaced by high NA waveguide mode converter segments. In another embodiment of the invention, a modal field transformer comprises a SMF that is connected to a high NA waveguide mode converter segment, which is connected to a waveguide mode converter. The waveguide mode converter is connected to a photonic circuit of a planar waveguide device. The high NA waveguide mode converter segment can be fabricated as a separate planar waveguide device. The high NA waveguide mode converter segment can be designed with similar optical characteristics to the high NA fiber described in the first embodiment. The high NA waveguide mode converter segment can be designed similar to the waveguide mode converter, as shown in FIG. 2 and FIG. 3, with larger dimensions and different NA values.

The invention can also be used for coupling an array of optical fibers to an array of high NA waveguides.

The modal field transformer is not restricted to these converter designs. Other methods of connecting waveguides to fibers or splicing fibers together, such as epoxy splicing or lens coupling, may also be used.

While this invention has been particularly shown and described with references to preferred embodiments thereof, it will be understood by those skilled in the art that various changes in form and details may be made therein without departing from the scope of the invention encompassed by the appended claims.

What is claimed is:

1. A mode field transformer for a planar waveguide device comprising:
a fiber segment coupled to an end of an optical fiber, a proximal end of the fiber segment having a higher numerical aperture than the optical fiber; and
a mode converter of the planar waveguide device, the proximal end of the fiber segment coupling to the mode converter.

2. A mode field transformer as claimed in claim 1, wherein a distal end of the fiber segment is directly connected to the optical fiber.

3. A mode field transformer as claimed in claim 1, wherein a distal end of the fiber segment is coupled to the optical fiber through an intervening second fiber segment.

4. A mode field transformer as claimed in claim 1, wherein the numerical aperture of the proximal end of the fiber segment is greater than about 0.15.

5. A mode field transformer as claimed in claim 1, wherein the planar waveguide device has a high refractive index contrast between waveguide cores and waveguide cladding.

6. A mode field transformer as claimed in claim 1, wherein the planar waveguide device has refractive index contrast between waveguide cores and waveguide cladding of greater than 2%.

7. A mode field transformer as claimed in claim 1, wherein the planar waveguide device has refractive index contrast between waveguide cores and waveguide cladding of greater than 5%.

8. A mode field transformer as claimed in claim 1, wherein the planar waveguide device has refractive index contrast between waveguide cores and waveguide cladding of greater than 10%.

9. A mode field transformer as claimed in claim 1, wherein the mode converter is tapered in a lateral direction of the waveguide.

10. A mode field transformer as claimed in claim 1, wherein a proximal end of the mode converter comprises two sections with two different lateral widths.

11. A mode field transformer as claimed in claim 1, wherein a coupling efficiency between the fiber segment and the mode converter is balanced for two orthogonal polarization modes.

12. A mode field transformer as claimed in claim 1, wherein a distal end of the fiber segment is thermal diffuision expanded core spliced.

13. A mode field transformer as claimed in claim 1, wherein the end of the optical fiber is thermal diffusion expanded core spliced to a distal end of the fiber segment.

14. A mode field transformer as claimed in claim 1, wherein the mode converter is adiabatic.

15. A mode field transformer as claimed in claim 1, wherein a connection between the fiber segment and the end of the optical fiber forms an adiabatic transition.

16. A mode field transformer as claimed in claim 1, wherein the optical fiber is gain fiber.

17. A mode field transformer as claimed in claim 1, wherein the mode converter is tapered in a transverse direction of the waveguide.

18. A mode field transformer for a planar waveguide device comprising:
a waveguide mode converter segment coupled to an end of an optical fiber, a proximal end of the waveguide mode converter segment having a higher numerical aperture than the optical fiber; and
a mode converter of the planar waveguide device, the proximal end of the waveguide mode converter segment coupling to the mode converter.

19. A mode field transformer as claimed in claim 18, wherein a distal end of the waveguide mode converter segment is directly connected to the optical fiber.

20. A mode field transformer as claimed in claim 1, wherein a distal end of the waveguide mode converter segment is coupled to the optical fiber through an intervening second fiber segment.

21. A mode field transformer as claimed in claim 18, wherein the numerical aperture of the proximal end of the waveguide mode converter segment is greater than about 0.15.

22. A mode field transformer as claimed in claim 18, wherein the planar waveguide device has a high refractive index contrast between waveguide cores and waveguide cladding.

23. A mode field transformer as claimed in claim 18, wherein the planar waveguide device has refractive index contrast between waveguide cores and waveguide cladding of greater than 2%.

24. A mode field transformer as claimed in claim 18, wherein the planar waveguide device has refractive index contrast between waveguide cores and waveguide cladding of greater than 5%.

25. A mode field transformer as claimed in claim 18, wherein the planar waveguide device has refractive index contrast between waveguide cores and waveguide cladding of greater than 10%.

26. A mode field transformer as claimed in claim 18, wherein the waveguide mode converter segment is tapered in a lateral direction of the waveguide.

27. A mode field transformer as claimed in claim 18, wherein a proximal end of the waveguide mode converter segment comprises two sections with two different lateral widths.

28. A mode field transformer as claimed in claim 18, wherein the mode converter is tapered in a lateral direction of the waveguide.

29. A mode field transformer as claimed in claim 18, wherein a proximal end of the mode converter comprises two sections with two different lateral widths.

30. A mode field transformer as claimed in claim 18, wherein a coupling efficiency between the waveguide mode converter segment and the mode converter is balanced for two orthogonal polarization modes.

31. A mode field transformer as claimed in claim 18, wherein the waveguide mode converter segment is adiabatic.

32. A mode field transformer as claimed in claim 18, wherein the mode converter is adiabatic.

33. A mode field transformer as claimed in claim 18, wherein the optical fiber is gain fiber.

34. A mode field transformer as claimed in claim 18, wherein the waveguide mode converter segment is tapered in a transverse direction of the waveguide.

35. A mode field transformer as claimed in claim 18, wherein the mode converter is tapered in a transverse direction of the waveguide.
